(19) United States
(12) Patent Application Publication
(10) Pub. No.: US 2016/0364621 A1
(43) Pub. Date: Dec. 15, 2016

(54) NAVIGATION DEVICE WITH INTEGRATED CAMERA

(71) Applicant: Garmin Switzerland GmbH, Schaffhausen (CH)

(72) Inventors: Kyle J. Hill, Lenexa, KS (US); Rares Bradi, Medias (RO); Jeffrey M. Hill, Olathe, KS (US)

(21) Appl. No.: 14/751,258

(22) Filed: Jun. 26, 2015

Related U.S. Application Data
(60) Provisional application No. 62/174,386, filed on Jun. 11, 2015.

(51) Int. Cl. G06K 9/00; G01S 19/13; G06T 7/20; B60R 1/00; G06K 9/62; G01B 11/14; G01C 21/36; B60Q 9/00

(52) U.S. Cl. CPC G06K 9/00805; G01C 21/3602; G01S 19/13; B60Q 9/00; B60R 1/00; G06K 9/6256; G06K 9/6267; G01B 11/14; G06K 9/00798; G06T 7/20; G06T 2207/20081

(57) ABSTRACT

Various embodiments are disclosed describing implementations of a navigational device with an integrated camera, which may record live video. A driving recorder is described that may store the live video data upon detection of a triggering event. A lane departure notification system is also described that determines whether a vehicle has crossed a road lane line, and cartographic data used by the navigational system may be leveraged such that the alert is issued when the vehicle is crossing into oncoming traffic but otherwise is suppressed. A collision notification system is also described, which identifies a vehicle by applying separate classification algorithms to the live video data based upon whether the video is recorded during the daytime or nighttime, and calculates a following distance. The navigational device may issue an alert when the following distance is below a recommended following distance threshold.

### CROSS-REFERENCE TO RELATED APPLICATIONS

The priority benefit of U.S. Provisional Patent Application No. 62/174,386, entitled “Navigation Device with Integrated Camera,” filed on Jun. 11, 2015, is claimed and the disclosure of which is hereby incorporated by reference in its entirety.

### BACKGROUND

Conventional driving recorder devices typically record video continuously, requiring the recorded video data to be frequently transferred from the driving recorder to free up space or otherwise be deleted. When not recording continuously, typical driving recorders also require a user to manually start the recording process. Conventional driving recorders are also generally installed as an aftermarket dedicated system, adding further clutter to a vehicle that may utilize other aftermarket dedicated systems such as navigation systems, radar detectors, smartphones, toll-payment transponders, etc.

Other typical in-vehicle devices include aftermarket or original equipment manufacturer (OEM) equipment, such as lane departure notification systems and collision notification systems. Aftermarket lane departure notification systems may detect that a vehicle has crossed into another lane and sound an alarm. But, as these systems are standalone devices, they cannot determine whether a driver intends to change lanes or has done so accidentally, and are therefore prone to false alarms.

Conventional OEM lane departure notification systems may utilize onboard sensors to detect changes in the vehicle's movement, steering wheel rotation, and turn signal activation to determine whether to sound a lane departure alarm, which may reduce the frequency of false alarms. However, conventional OEM lane departure notification systems cannot discriminate between accidental lane changes and intentional lane changes, which may lead to alarms being sounded when the driver is fully aware of the lane change.

Typical collision notification systems also utilize onboard sensor data (e.g., in the case of OEM systems) or analyze captured video to determine a following distance (e.g., in the case of standalone systems) and issue an alarm if the driver is following too closely. However, analysis of captured video is typically performed using a single type of detection analysis regardless of the time of day. Because the images of the rear of a vehicle may drastically change based upon lighting conditions, the use of a single type of analysis may adversely impact how accurately vehicles are detected.

As a result, current driving recorder devices and in-vehicle safety equipment have several drawbacks.

### SUMMARY

Embodiments of the present technology relate generally to aftermarket navigation systems used in a vehicle.

Embodiments are disclosed describing a driving recorder. The driving recorder may be integrated as part of an aftermarket navigational system, thereby consolidating a driving recorder and a navigational system into a single aftermarket device. The device may include one or more sensors and/or cameras positioned to automatically record video in front of the vehicle, which may be recorded continuously, in a memory buffer, and/or manually. Embodiments include the device utilizing sensory input to detect triggering events (e.g., an accident) that result in the start of video recording and/or the transfer of buffered video to a more permanent form of memory, such as a removable memory card, for example.

Other embodiments are disclosed that describe a lane departure notification system. The lane departure notification system may utilize cartographic data stored as part of the navigational system to identify a type of road (road type) upon which the vehicle is traveling. The type of road information may indicate the direction of traffic (e.g., one way or two way) and the number of lanes for each direction of traffic for each road. For instance, a processor may use the type of road information to determine that the road being traveled is a two-way road with two lanes for each direction of traffic. When a vehicle lane departure is detected, the lane departure notification system may selectively issue an alert when the road type indicates that the vehicle may be veering off into oncoming traffic, but otherwise suppress the alert. For instance, the lane departure notification system may suppress the alert if the vehicle is determined to be traveling on a two-way road with two lanes for each direction and the vehicle is crossing from the right lane to the left lane while maintaining the direction of movement. The first alert may be suppressed when the vehicle is determined to cross the dashed road lane line and enter a different lane in the same direction of travel. The lane departure notification system may also suppress the alert if the vehicle is determined to be traveling on a one-way road with one or more lanes for the permitted direction of travel and the vehicle is crossing from one lane to another lane while maintaining the direction of movement.

In still other embodiments, a collision notification system is described. The collision notification system may utilize captured live video data (e.g., mounted as a dash cam) and determine whether the rear of a vehicle is present in the live video data. By performing an analysis of the live video data, portions of one or more vehicles (e.g., the rear of a vehicle) within the live video data may be identified. Once the collision prevention system detects the rear of at least one vehicle in the video, a mathematical algorithm may be applied to the live video data to determine a following distance, and an alert may be issued if the estimated distance is less than a threshold recommended following distance (RFD). In embodiments, a processor may determine an estimated distance from a navigation device (and the vehicle within which the navigation device 102 is located) to a vehicle within the live video data and an estimated time to impact for the vehicle within which the navigation device 102 is located to the identified vehicle determined to be present in the live video data. When a plurality of vehicles are determined to be present in the live video data, the collision prevention system may identify a single vehicle of interest and determine a following distance to that vehicle.

Because the collision notification system may be integrated with a navigational system, the time of day and geographic data may be leveraged to determine whether the video is being captured during the daytime or nighttime. The collision notification system may classify the video data using different training data models for videos captured during the daytime and nighttime to better identify the rear of a vehicle.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, whenever possible, the following description refers to the reference numerals included in the following figures, in which features depicted in multiple figures are designated with consistent reference numerals.

FIG. 1 is an illustration of a block diagram of an exemplary navigation system 100 in accordance with an embodiment of the present disclosure;

FIGS. 2A-2C are schematic illustration examples of user interface screens 200 used to implement a navigation device as a driving recorder, according to an embodiment;

FIGS. 3A-3B are schematic illustration examples of user interface screens 300 used in conjunction with a navigation system, according to an embodiment;

FIGS. 4A-4D are schematic illustration examples of user interface screens 400 used to implement a navigation device in conjunction with a lane departure notification system, according to an embodiment;

FIG. 5A is a schematic illustration example of a one-way street 500 showing road lane line markings, according to an embodiment;

FIG. 5B is a schematic illustration example of two-lane undivided highway 550 showing road lane line markings, according to an embodiment;

FIG. 6 illustrates a method flow 600, according to an embodiment;

FIGS. 7A-7C are schematic illustration examples of user interface screens 700 used to implement a navigation device in conjunction with a collision notification system, according to an embodiment;

FIG. 8A is a schematic illustration example 800 of the rear of a vehicle within live video captured during the daytime, according to an embodiment;

FIG. 8B is a schematic illustration example 850 of the rear of a vehicle within live video captured during the nighttime, according to an embodiment; and

FIG. 9 illustrates a method flow 900, according to an embodiment.

### DETAILED DESCRIPTION

The following text sets forth a detailed description of numerous different embodiments. However, it should be understood that the detailed description is to be construed as exemplary only and does not describe every possible embodiment since describing every possible embodiment would be impractical. In light of the teachings and disclosures herein, numerous alternative embodiments may be implemented.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

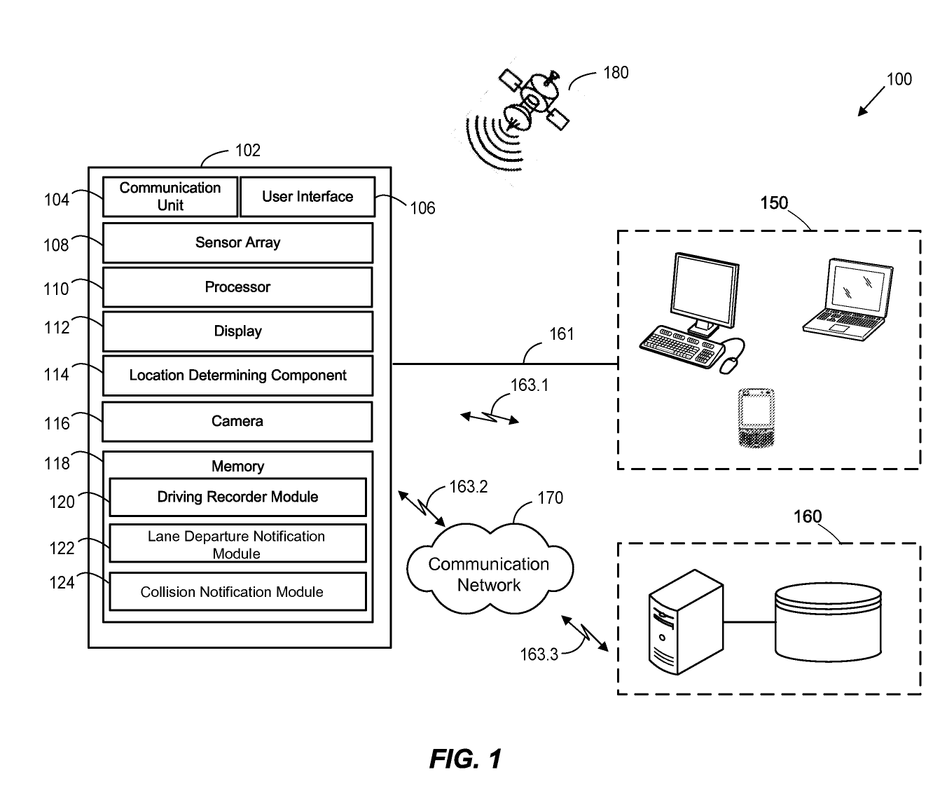

FIG. 1 is an illustration of a block diagram of an exemplary navigation system 100 in accordance with an embodiment of the present disclosure.

In some embodiments, navigation device 102 may act as a standalone device and not require communications with external computing devices 150 or 160. But in other embodiments, which are further discussed below, navigation device 102 may communicate with and/or work in conjunction with one or more of external computing devices 150 and/or 160.

Navigation device 102, one or more external computing devices 150, and/or one or more external computing devices 160 may be configured to communicate with one another using any suitable number of communication networks and wired and/or wireless links (e.g., communication network 170, wired link 161, and/or wireless links 163.1-163.3) in conjunction with any suitable number and type of communication protocols.

In an embodiment, one or more of external computing devices 150 and/or external computing devices 160 may include any suitable number and/or type of computing devices configured to communicate with and/or exchange data with navigation device 102. For example, one or more of external computing devices 150 may be implemented as a mobile computing device (e.g., smartphone, tablet, laptop, phablet, netbook, notebook, pager, personal digital assistant (PDA), wearable computing device, smart glasses, a smart watch or a bracelet, etc.), or any other suitable type of computing device capable of wired and/or wireless communication (e.g., a desktop computer), while one or more of external computing devices 160 may be implemented as one or more traffic data services, web servers, databases, etc.

In an embodiment, navigation device 102 may communicate with one or more of external computing devices 150 and/or external computing devices 160 to send data to and/or to receive data from external computing devices 150 and/or external computing devices 160. For example, navigation device 102 may communicate with one or more external computing devices 150 to receive updated cartographic data. To provide another example, navigation device 102 may communicate with one or more external computing devices 160 to receive traffic data and/or to send data collected, measured, and/or generated by navigation device 102 to external computing devices 160 (e.g., road lane data, road type data, etc., as further discussed below).

Communication network 170 may include any suitable number of nodes, additional wired and/or wireless networks, etc., in various embodiments. For example, in an embodiment, communication network 170 may be implemented with any suitable number of base stations, landline connections, internet service provider (ISP) backbone connections, satellite links, public switched telephone network (PSTN) connections, local area networks (LANs), metropolitan area networks (MANs), wide area networks (WANs), any suitable combination of local and/or external network connections, etc. To provide further examples, communication network 170 may include wired telephone and/or cable hardware, satellite, cellular phone communication networks, etc. In various embodiments, communication network 170 may provide navigation device 102 with connectivity to network services, such as Internet services, for example.

Communication network 170 may be configured to support communications between navigation device 102 and external computing devices 160 in accordance with any suitable number and/or type of wired and/or wireless communication protocols. Examples of suitable communication protocols may include personal area network (PAN) communication protocols (e.g., BLUETOOTH), Wi-Fi communication protocols, radio frequency identification (RFID) and/or a near field communication (NFC) protocols, cellular communication protocols, Internet communication protocols (e.g., Transmission Control Protocol (TCP) and Internet Protocol (IP)), etc.

In another embodiment, navigation device 102 need not communicate with one or more of external computing devices 150 and/or 160. For example, as will be further discussed below, navigation device 102 may operate as a standalone navigation device that is installed in a vehicle to perform various functions.

Navigation device 102 may be implemented as any suitable type of portable and/or mobile device configured to function as a driving recorder, lane departure notification system, and/or collision notification system. Embodiments include navigation device 102 implementing any suitable combination of these functions. Navigation device 102 may implement some of these functions without implementing others.

In an embodiment, navigation device 102 may include a communication unit 104, a user interface 106, a sensor array 108, one or more processors 110, a display 112, a location determining component 114, a camera 116, and a memory 118. Navigation device 102 may include additional elements such as, for example, power sources, memory controllers, memory card slots, ports, interconnects, etc., which are not described herein for purposes of brevity.

Communication unit 104 may be configured to support any suitable number and/or type of communication protocols to facilitate communications between navigation device 102 and one or more of external computing devices 150 and/or external computing devices 160. Communication unit 104 may be configured to receive any suitable type of information via one or more of external computing devices 150 and/or external computing devices 160. Communication unit 104 may be implemented with any suitable combination of hardware and/or software to facilitate this functionality. For example, communication unit 104 may be implemented with any number of wired and/or wireless transceivers, ports, connectors, antennas, etc.

Communication unit 104 may be configured to facilitate communications with various external computing devices 150 and/or external computing devices 160 using different types of communication protocols. For example, communication unit 104 may communicate with a mobile computing device via a wireless BLUETOOTH communication protocol (e.g., via wireless link 163.1) and with a laptop or a personal computer via a wired universal serial bus (USB) protocol (e.g., via wired link 161). To provide another example, communication unit 104 may communicate with a traffic aggregation service via network 170 using a wireless cellular protocol (e.g., via links 163.1-163.3). Communication unit 104 may be configured to support simultaneous or separate communications between two or more of external computing devices 150 and/or external computing devices 160.

User interface 106 may be configured to facilitate user interaction with navigation device 102 and/or to provide feedback to a user. In an embodiment, a user may interact with user interface 106 to change various modes of operation, to initiate certain functions, to modify settings, set options, etc., which are further discussed below.

For example, user interface 106 may include a user-input device such as an interactive portion of display 112 (e.g., a “soft” keyboard, buttons, etc.) displayed on display 112), physical buttons integrated as part of navigation device 102 that may have dedicated and/or multi-purpose functionality, etc. To provide another example, user interface 106 may cause visual alerts to be displayed via display 112 and/or audible alerts to be sounded. Audible alerts may be sounded using any suitable device, such as a buzzer, speaker, etc., which are not shown in FIG. 1 for purposes of brevity.

Sensor array 108 may be implemented as any suitable number and/or type of sensors configured to measure, monitor, and/or quantify one or more characteristics of navigation device 102's environment as sensor data metrics. For example, sensor array 108 may measure the acceleration of navigation device 102 in one or more directions and, as a result, measure the acceleration of the vehicle in which navigation device 102 is mounted. To provide another example, sensor array 108 may measure other sensor data metrics such as light intensity, magnetic field direction and intensity (e.g., to display a compass direction), etc.

Sensor array 108 may be advantageously mounted or otherwise positioned within navigation device 102 to facilitate these functions. Sensor array 108 may be configured to sample sensor data metrics and/or to generate sensor data metrics continuously or in accordance with any suitable recurring schedule, such as, for example, on the order of several milliseconds (e.g., 10 ms, 100 ms, etc.), once per every second, once per every 5 seconds, once per every 10 seconds, once per every 30 seconds, once per minute, etc.

Examples of suitable sensor types implemented by sensor array 108 may include one or more accelerometers, gyroscopes, perspiration detectors, compasses, speedometers, magnetometers, barometers, thermometers, proximity sensors, light sensors (e.g., light intensity detectors), photodetectors, photoresistors, photodiodes, Hall Effect sensors, electromagnetic radiation sensors (e.g., infrared and/or ultraviolet radiation sensors), ultrasonic and/or infrared range detectors, humistors, hygrometers, altimeters, biometrics sensors (e.g., heart rate monitors, blood pressure monitors, skin temperature monitors), microphones, etc.

Display 112 may be implemented as any suitable type of display configured to facilitate user interaction, such as a capacitive touch screen display, a resistive touch screen display, etc. In various aspects, display 112 may be configured to work in conjunction with user interface 106 and/or processor 110 to detect user inputs upon a user selecting a displayed interactive icon or other graphic, to identify user selections of objects displayed via display 112, etc.

Location determining component 114 may be configured to utilize any suitable communications protocol to facilitate determining a geographic location of navigation device 102. For example, location determining component 114 may be configured to communicate with one or more satellites 180 and/or wireless transmitters in accordance with a Global Navigation Satellite System (GNSS) protocol, to determine a geographic location of navigation device 102, and to generate geographic location data. Wireless transmitters are not illustrated in FIG. 1, but may include, for example, one or more base stations implemented as part of communication network 170.

For example, location determining component 114 may be configured to utilize “Assisted Global Positioning System” (A-GPS), by receiving communications from a combination of base stations (that may be incorporated as part of communication network 170) and/or from satellites 180. Examples of suitable global positioning communications protocol may include Global Positioning System (GPS), the GLONASS system operated by the Russian government, the Galileo system operated by the European Union, the BeiDou system operated by the Chinese government, etc.

Camera 116 may be configured to capture pictures and/or videos and to generate live video data. Camera 116 may include any suitable combination of hardware and/or software such as image sensors, optical stabilizers, image buffers, frame buffers, charge-coupled devices (CCDs), complementary metal oxide semiconductor (CMOS) devices, etc., to facilitate this functionality.

In an embodiment, camera 116 may be housed within or otherwise integrated as part of navigation device 102. Camera 116 may be strategically mounted on navigation device 102 such that, when navigation device 102 is mounted in a vehicle, camera 116 may capture live video and generate live video data of the road and/or other objects in front of the vehicle in which navigation device 102 is mounted. For example, camera 116 may be mounted on a side of navigation device 102 that is opposite of display 112, allowing a user to view display 112 while camera 116 captures live video and generated live video data.

Processor 110 may be implemented as any suitable type and/or number of processors, such as a host processor of navigation device 102, for example. To provide additional examples, processor 110 may be implemented as an application specific integrated circuit (ASIC), an embedded processor, a central processing unit (CPU) associated with navigation device 102, a graphical processing unit (GPU), etc.

Processor 110 may be configured to communicate with one or more of communication unit 104, user interface 106, sensor array 108, display 112, location determining component 114, camera 116, and memory 118 via one or more wired and/or wireless interconnections, such as any suitable number of data and/or address buses, for example. These interconnections are not shown in FIG. 1 for purposes of brevity.

Processor 110 may be configured to operate in conjunction with one or more of communication unit 104, user interface 106, sensor array 108, display 112, location determining component 114, camera 116, and memory 118 to process and/or analyze data, to store data to memory 118, to retrieve data from memory 118, to display information on display 110, to receive, process, and/or interpret sensor data metrics from sensor array 108, to process user interactions via user interface 106, to receive and/or analyze live video data captured via camera 116, to determine whether a lane departure notification and/or vehicle proximity warning should be issued, to receive data from and/or send data to one or more of external computing devices 150 and/or 160, etc.

In accordance with various embodiments, memory 118 may be a computer-readable non-transitory storage device that may include any suitable combination of volatile memory (e.g., a random access memory (RAM) or non-volatile memory (e.g., battery-backed RAM, FLASH, etc.). Memory 118 may be configured to store instructions executable on processor 110, such as the various memory modules illustrated in FIG. 1 and further discussed below, for example. These instructions may include machine readable instructions that, when executed by processor 110, cause processor 110 to perform various acts as described herein. Memory 118 may also be configured to store any other suitable data used in conjunction with navigation device 102, such as data received from one or more of external computing devices 150 and/or 160 via communication unit 104, sensor data metrics from sensor array 108 and information processed by processor 110, buffered live video data, cartographic data, data indicative of sunrise and sunset times by geographic location, etc.

Memory 118 may include a first portion implemented as integrated, non-removable memory and a second portion implemented as a removable storage device, such as a removable memory card. For example, memory 118 may include a SD card that is removable from navigation device 102 and a flash memory that is not removable from navigation device 102. Data may be transferred from a first portion of memory 118 (e.g., buffered live video data) to a second portion of memory 118, thereby allowing a user to remove a portion of memory 118 to access viewing data stored thereon on another device.

Driving recorder module 120 is a region of memory 118 configured to store instructions that, when executed by processor 106, cause processor 110 to perform various acts in accordance with applicable embodiments as described herein.

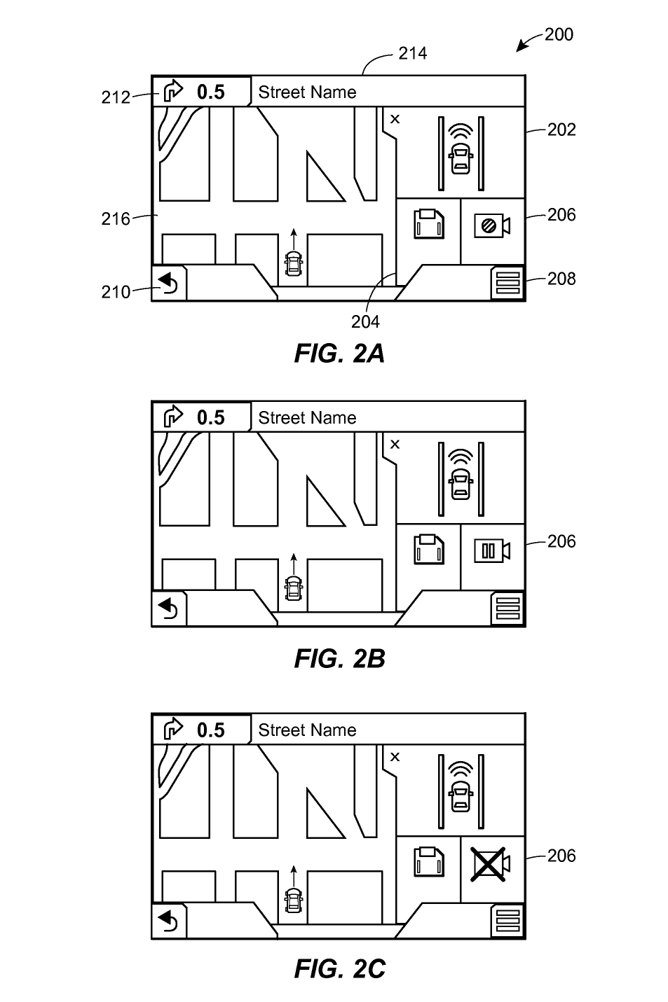

In an embodiment, driving recorder module 120 includes instructions that, when executed by processor 110, cause processor 110 to record live video data generated via camera 116, to determine a recording and/or storage trigger, to store the live video data to memory 118, and/or to play stored live video data on display 112. These functions are further discussed below with respect to FIGS. 2A-2C.

In various embodiments, processor 110 may store live video data generated via camera 116 in various ways. For example, in one embodiment, driving recorder module 120 may include instructions that, when executed by processor 110, cause processor 110 to continuously store live video data to memory 118. In accordance with such embodiments, the recording of the live video data may be triggered by the passage of a certain period of time after navigation device 102 is powered on, when threshold movement is exceeded (e.g., via sensor data metrics generated via sensor array 108), when a threshold speed is exceeded, etc.

Further in accordance with continuous recording embodiments, the live video data may be overwritten once a portion of memory 118 allocated to store live video data has been filled to a threshold level (or a threshold amount of memory space is remaining), which may occur over the period of several hours, several days, etc., based upon the memory capacity of memory 118. Before being overwritten, processor 110 may cause display 112 to display an indication accordingly. In this way, a user may save the live video feed before it is overwritten if desired.

In another embodiment, driving recorder module 120 may include instructions that, when executed by processor 110, cause processor 110 to store live video data to memory 118 upon receipt of a trigger generated via user interface 106. For example, a user may manually select a recording option via a suitable graphic, icon, label, etc., displayed on display 112.

In yet other embodiments, driving recorder module 120 may include instructions that, when executed by processor 110, cause processor 110 to store live video data to memory 118 in a rolling buffer, which is continuously updated as new live video data is received until one or more storage triggers are detected. The rolling buffer size may be any suitable capacity to facilitate recording of live video for a duration of time allowing an event associated with the storage trigger to be captured, such as 30 seconds, 1 minute, 2 minutes, 5 minutes, 10 minutes, etc. A storage trigger may be based upon one or more sensor data metrics that are identified with a vehicular accident or other noteworthy event such that, when satisfied, a portion of the buffered live video data beginning shortly before the noteworthy event, such as 30 seconds, 1 minute, or 2 minutes, etc. prior to the noteworthy event, is moved to another portion of memory 118, such as a removable SD card. Once a noteworthy event occurs, processor 110 may also store in memory 118 a portion of the buffered live video data captured for a period of time, such as 5 minutes or 10 minutes, after the noteworthy event.

To provide an illustrative example, processor 110 may compare accelerometer data metrics to predetermined and/or known data profiles associated with the deceleration of a vehicle during a crash, a rollover, a sudden stop, etc. When the accelerometer data metrics are within a threshold value of the data profiles, processor 110 may determine that the storage trigger condition has been satisfied. Once a storage trigger is detected, the buffering of new live video data may momentarily stop and the buffer contents transferred, thereby preserving live video data of the event responsible for the generation of the storage trigger before it is flushed from the buffer, or continue buffering new live video data to capture additional footage after a noteworthy event.

It should be understood that processor 110 may account for variations in directions of traffic flow and lane types used in various countries. For instance, processor 110 may determine that navigation device 102 (and the vehicle within which the navigation device 102 is located) is located in a country where traffic flows on the right-side of each road and use that determination when providing lane departure notification functionality and collision notification functionality.

Lane departure notification module 122 is a region of memory 118 configured to store instructions, that when executed by processor 106, cause processor 110 to perform various acts in accordance with applicable embodiments as described herein.

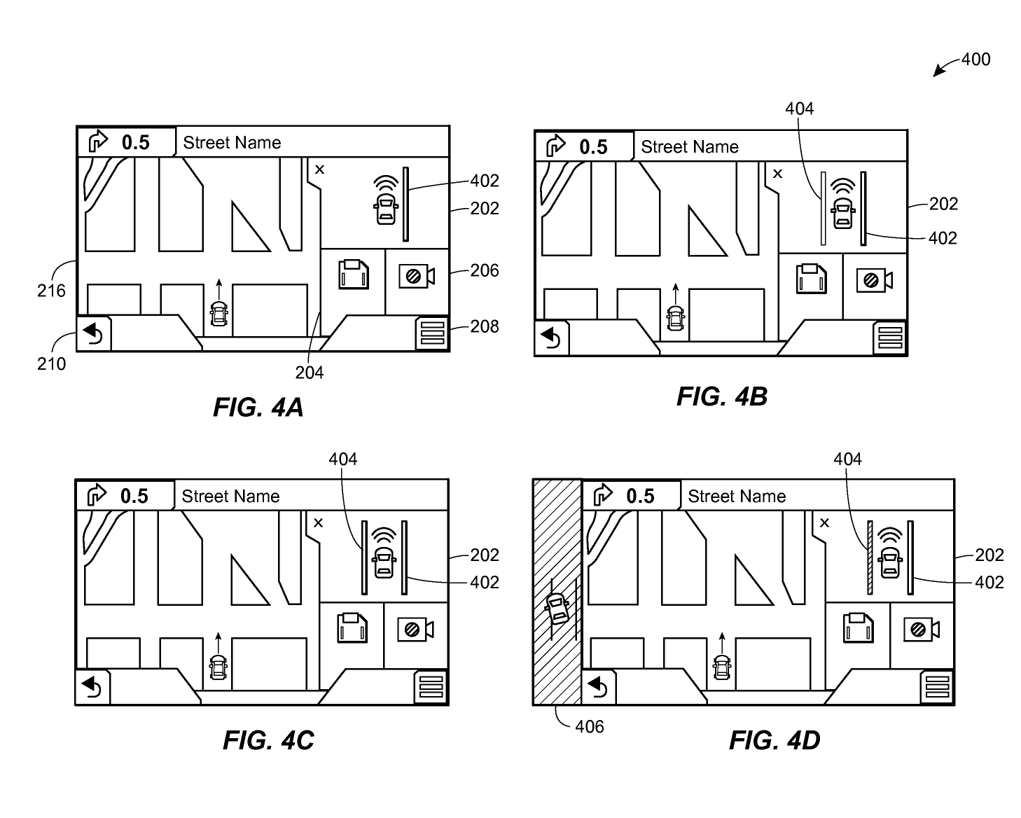

In an embodiment, lane departure notification module 122 includes instructions that, when executed by processor 110, cause processor 110 to analyze live video data generated via camera 116, to determine if the vehicle in which navigation device 102 is mounted has crossed a road lane line, to identify the crossed road lane line as a dashed or a solid road lane line, to reference cartographic data to determine a road type on which the vehicle is traveling, and to cause an alert to be issued based upon the type of the crossed road lane line in conjunction with the road type. These functions are further discussed below with respect to FIGS. 4A-4D.

In an embodiment, processor 110 may analyze the live video data in accordance with any suitable number and/or type of machine vision algorithms to detect road lane lines adjacent to the vehicle and to determine whether the road lane lines are dashed or solid road lane lines. For example, processor 110 may analyze the live video data using any suitable edge detection techniques, such as a Canny edge detection technique or other suitable types of search-based or zero-crossing based techniques that analyze variations in contrast, for example. As a result of the applied edge-detection, processor 110 may identify line segments within the live video data.

Once the line segments are identified via edge detection (or other suitable techniques), embodiments include processor 110 identifying a vanishing point within the live video data based upon a convergence of identified line segments having a particular length longer than other identified line segments, which may be represented by exceeding a number of pixels within the live video data, for example. For example, solid and dashed road lane lines may have pixel dimensions of a threshold size that is greater than other identified line segments within the live video data.

After identifying the vanishing point within the live video data, embodiments include processor 110 compensating for the position of navigation device 102 within the vehicle based upon the identified vanishing point. That is, navigation device 102 may be mounted on the left, center, or right of a dashboard within a vehicle. Without knowledge of the vanishing point, it is difficult to ascertain a reference point to identify road lane lines with respect to the vehicle, as a left-mounted navigation device may record live video showing a left line closer than it actually is. But with knowledge of the vanishing point within the live video data, processor 110 may establish a reference point by mapping the vanishing point to the current lane in which the vehicle is traveling, thereby compensating for image skewing and/or various positions of navigation device 102.

In some embodiments, a user may further assist this compensation process by specifying the mounting position of navigation device 102 on the dashboard (e.g., as left, center, or right) via user interface 106. In accordance with such embodiments, processor 110 may utilize this selection to further compensate for the position of navigation device 102 to identify the road lane lines.

For example, when a left-mounting configuration is entered by a user, processor 110 may adjust for the road lane lines to the right and left of the vehicle appearing closer to the left within the live video data. In an embodiment, processor 110 may apply left, center, and right compensating profiles whereby this offset is accounted for via a predetermined offset number of pixels, the live video data shifting the road lane lines by a preset amount based upon the profile selection when the images are processed, etc.

Using the vanishing point as a reference point in this way, embodiments include processor 110 identifying lines adjacent to those used to establish the vanishing point as the road lane lines to the left and right of the vehicle. In other words, a “reference” lane may be determined using the lines adjacent to the vehicle to identify a current lane in which the vehicle is traveling. Based upon this reference lane, processor 110 may identify the shape of other nearby parallel road lane lines and the overall shape of the road. Using the movement of the identified road lanes with respect to the established vanishing point, a determination may also be made as to whether the vehicle, in which the navigation device 102 is located, may cross or has already crossed one of the adjacent road lane lines and thereby exiting the reference lane. When the vehicle moves into an adjacent road lane, embodiments include processor 110 repeating this process to identify a new reference lane.

In an embodiment, processor 110 may execute instructions stored in lane departure notification module 122 to categorize the identified road lane lines within the live video data as dashed and solid lines. This may be performed, for example, via a comparison of the number of occupied pixels with respect to the height and/or width of the captured live video data. Identified lane lines occupying a greater pixel length are classified as solid lane lines, while identified lane lines occupying less pixels are classified as dashed lane lines. In an embodiment, any suitable threshold may be selected as the number of pixel to facilitate the differentiation between solid and dashed lane lines.

In an embodiment, navigation device 102 may provide navigational guidance. Therefore, navigational device 102 may store cartographic data in memory 118. This cartographic data may include, for example, road types (e.g., one-way, highway, freeway, tollway, divided highway, etc.) an indication of the number of lanes, map data used in conjunction with the geographic location data and provide route guidance, etc.

In an embodiment, processor 110 may reference the cartographic data to the geographic location data to determine a road type and/or characteristics of the road upon which the vehicle is currently traveling. Processor 110 may execute instructions stored in lane departure notification module 122 to condition the issuance of a lane departure alert by leveraging this cartographic data.

That is, if processor 110 detects that a vehicle has crossed an adjacent solid road lane line, processor may cause an alert to be issued. But if processor 110 detects that the vehicle has crossed an adjacent road lane line that is a dashed line, the alert may not be necessary as the vehicle may be changing lanes, and the driver is fully aware of the lane change. In an embodiment, when processor 110 detects that the vehicle has crossed a dashed road lane line, processor 110 may conditionally issue the alert when the vehicle is crossing into oncoming traffic, but otherwise suppress the alert.

To provide an illustrative example, processor 110 may detect that the vehicle has crossed an adjacent dashed road lane line but, by referencing the cartographic data to the geographic location data, determine that the road is a one-way street and thus suppress the alert.

To provide another illustrative example, processor 110 may detect that the vehicle has crossed an adjacent dashed road lane line to the left of the vehicle. Again, by referencing the cartographic data to the geographic location data, processor 110 may determine that the road is a two-way highway and that crossing the dashed lane in this case would result in the vehicle crossing into oncoming traffic. In this scenario, processor 110 may cause the alert to be appropriately issued.

In this way, the cartographic data may be leveraged to issue a lane departure alert only when the vehicle is crossing into oncoming traffic, and otherwise suppress the alert. This advantageously allows for a navigation device 102, when implemented as a standalone device, to more accurately discriminate between intentional and unintentional lane changes without access to vehicle sensors.

In various embodiments, processor 110 may utilize any suitable number and/or type of road lane line characteristics to determine whether to issue a lane departure notification alert, which may or may not utilize the cartographic data. For example, embodiments include the identification of road lane line colors as yellow or white. Processor 110 may issue an alert when the vehicle crosses a yellow dashed line but suppress the alert when the vehicle crosses a white dashed line.

Collision notification module 124 is a region of memory 118 configured to store instructions, that when executed by processor 110, cause processor 110 to perform various acts in accordance with applicable embodiments as described herein.

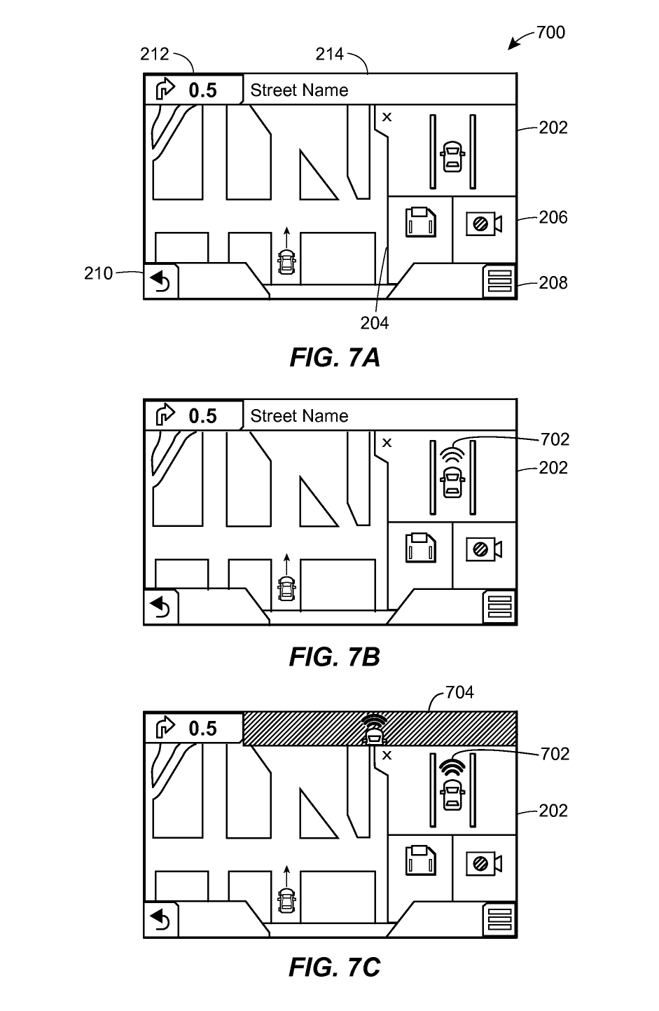

In embodiments, collision notification module 124 includes instructions that, when executed by processor 110, cause processor 110 to analyze live video data generated via camera 116, to classify the live video data according to either a daytime training model or a nighttime training model, to identify a portion of at least one vehicle within the live video data, to calculate an estimated distance from the navigation device 102 (and the vehicle within which the navigation device 102 is located) to the identified vehicle determined to be present in the live video data, and to cause an alert to be issued when an estimated distance from the navigation device 102 to the identified vehicle is less than a threshold RFD. These functions are further discussed below with respect to FIGS. 7A-7C.

In some embodiments, collision notification module 124 includes instructions that, when executed by processor 110, cause processor 110 to analyze live video data generated via camera 116, to classify the live video data according to either a daytime training model or a nighttime training model, to identify a portion of at least one vehicle within the live video data, to calculate an estimated time to impact for the vehicle within which the navigation device 102 is located to the identified vehicle determined to be present in the live video data, and to cause an alert to be issued when an estimated time to impact to the identified vehicle is less than a threshold RFD.

In embodiments, memory 118 may be configured to store various training data models. These training data models may include, for example, a daytime data training model corresponding to one range of video data metrics that indicate that a portion of a vehicle is contained within the live video data during the daytime, and a nighttime training data model corresponding to another range of video data metrics that indicate the portion of a vehicle is contained within the live video data during the nighttime. These metrics may include any metrics suitable for the classification of live video data images by comparison to these training data models, such as brightness, groupings of pixels forming specific patterns or shapes, pixel coloration, edges detected within the live video data, contrasting portions within the live video data, histograms, image statistics (e.g., mean, standard deviation, image moments, etc.), filters, image gradient, etc.

In an embodiment, memory 118 may store daytime training data models including video data from several sampled images that correspond to a portion of a vehicle (e.g., the rear portion) being in front of the vehicle in which navigation device 102 is mounted. For example, the training data models may include many (more than 1000) image samples of various vehicle rear ends, which may include various vehicle models, colors, shapes, angles, etc. In an embodiment, the classification process may include processor 110 executing instructions stored in collision notification module 124 to compare live video data to several of the training data models to attempt to identify whether a portion of a vehicle (e.g., the rear portion) is contained within the live video data.

Based on the output from the executed classification algorithm on the live video data, a determination may be made based upon the characteristics utilized by that particular classification algorithm. Processor 110 may use any suitable type and/or number of classification algorithms to make this determination. For example, collision notification module 124 may store instructions that, when executed by processor 110, cause processor 110 to execute a linear classifier algorithm, a support vector machine algorithm, a quadratic classifier algorithm, a kernel estimation algorithm, a boosting meta-algorithm, a decision tree algorithm, a neural network algorithm, a learning vector quantization algorithm, etc.

Although embodiments include any suitable classification algorithm being executed to attempt to identify the presence of a portion of a vehicle within the live video data, environmental conditions such as lighting may impact the outcome. In an embodiment, daytime training data models and nighttime training data models may have lighting features that differ from one another, as each set of training data models include vehicle images taken during the daytime and nighttime, respectively.

For example, the presence of taillights may be prominent in nighttime vehicle images while being absent in daytime images. To provide another example, the contrast between edges in daytime vehicle images may be more prominent those of in nighttime vehicle images. Therefore, the selection of which set of model training data used in the classification process may impact the accuracy and efficiency of identifying a portion of the vehicle within the live video data. Using daytime training data models as a basis for the classification of live video data captured during the nighttime may result in a portion of the vehicle not being identified within the live video data, a false identification, etc. Similarly, using nighttime training data models as a basis for the classification of live video data captured during the daytime may not provide accurate results.

Therefore, embodiments include processor 110 executing instructions stored in collision notification module 124 to perform classification on live video data using daytime training data models when the live video data is captured during the daytime, while using nighttime training data models when the live video data is captured during the nighttime.

Embodiments include processor 110 determining whether the live video data is captured during the “daytime” or “nighttime” using any suitable number and/or type of techniques. For example, location determining component 114 may receive Global Navigation Satellite System (GNSS) data and generate geographic location data indicative of a geographic location of the navigation device, which may be utilized by processor 110 to perform geographic location calculations. Using this signal, processor 110 may ascertain the time of day, as GNSS systems require time synchronization. Further in accordance with such an embodiment, processor 110 may utilize the geographic location data (e.g., latitude and longitude coordinates) to calculate a sunrise and sunset time corresponding to the location of navigation device 102 when the live video data was captured.

For example, sunrise and sunset times for ranges of latitude and longitude coordinates may be stored in any suitable portion of memory 118. Processor 110 may determine the sunrise and sunset time by referencing the geographic location data to the ranges of latitude and longitude coordinates stored in memory 118. Processor 110 may then compare the time of day to the sunset/sunrise times to make a more accurate determination of whether it is daytime or nighttime when the live video data is being captured.

To provide another example, the daytime/nighttime determination may be performed using sensory data generated by sensor array 108 (e.g., via photocells), a brightness and/or contrast analysis of the live video data, an ISO setting used by sensor array 108, an ISO data setting used by camera 116 (e.g., an automatically changing ISO setting will reduce when brighter images are captured), etc.

Regardless of the training data models that are used in the classification process, once the portion of at least one vehicle is identified in the live video data, embodiments include processor 110 executing instructions stored in collision notification system 124 to analyze the live video data and determine an estimated distance between navigation device 102 (and the vehicle within which the navigation device 102 is located) and the vehicle captured in the live video data. Embodiments include processor 110 calculating or estimating this distance using any suitable techniques, such as via application of an inverse perspective transform on the live video data. Processor 110 may obtain instructions from collision notification module 124 to determine a following distance and issue an alert if an estimated distance to the vehicle is less than a threshold recommended following distance (RFD). When a plurality of vehicles are determined to be present in the live video data, such as a first vehicle directly in front (in the same lane as the vehicle within which the navigation device 102 is located) and a second vehicle in an adjacent lane, processor 110 may identify a single vehicle of interest and determine a following distance to that vehicle. For instance, processor 110 may obtain instructions from collision notification module 124 to determine a recommended following distance (RFD) to the first vehicle directly in front while continuing to monitor the estimated distance to the second vehicle present in an adjacent lane.

Embodiments include processor 110 causing an alert to be sounded (e.g., a buzzer, beeper, etc., integrated as part of navigation device 102) and/or causing a warning to be displayed on display 112, etc., when the calculated estimated distance is less than a threshold RFD.

In various embodiments, the RFD may be calculated using the speed of the vehicle in which navigation device 102 is installed. The calculation of speed may be determined by leveraging the geographic location data generated via location determining component 114, advantageously allowing navigation device 102 to determine a RFD from changes in geographic location data without the need to communicate with onboard vehicle systems.

Using the vehicle speed, processor 110 may calculate the RFD based upon any suitable number and/or type of calculations, such as the “two-second rule,” for example, which is calculated based upon the estimated distance traversed by the vehicle over two seconds at the current speed. In various embodiments, processor 110 may use the same calculation for RFD regardless of the time of day, increase the threshold RFD for lighting considerations during the nighttime, increase the threshold RFD calculation as the speed of the vehicle increases (e.g., using a two-second rule below 45 mph but a three-second rule in excess of 45 mph), etc.

Additional location-based data may be used by processor 110 to calculate the RFD. For example, navigation device 102 may retrieve data from external computing devices 150 and/or 160 related to weather conditions. The RFD calculation may be increased in the event of weather conditions that may impact visibility or vehicle traction, such as rain, snow, sleet, ice, etc. In another example, navigation device 102 may retrieve data from external computing devices 150 and/or 160 related to traffic conditions. The RFD calculation may be impacted due to traffic flow and/or average traffic speeds due to congestion.

FIGS. 2A-2C are schematic illustration examples of user interface screens 200 used to implement a navigation device as a driving recorder, according to an embodiment. In an embodiment, user interface screens 200 are examples of what may be shown on display 112 of navigation device 102, as shown and previously discussed with respect to FIG. 1. In this embodiment and additional ones disclosed herein, user interaction with various portions of screens are discussed in terms of the portions being “selected” by a user. These selections may be performed via any suitable gesture, such as a user tapping his or her finger (or stylus) to that portion of the screen, for example.

As shown in FIG. 2A, user interface screen 200 includes portions 202, 204, 206, 208, 210, 212, 214, and 216. As further discussed below, each respective portion of user interface screen 200 may include a suitable indicia, label, text, graphic, icon, etc., to facilitate user interaction with navigation device 102 and/or to provide feedback from navigation device 102 to a user.

In an embodiment, portion 202 of user interface screen 200 provides information regarding an indication of the vehicle within road lanes and may be used in conjunction with the road lane departure notification system, the details of which are further discussed with reference to FIGS. 4A-4D. The graphic in front of the vehicle also indicates that the collision notification system is enabled, the details of which are further discussed with reference to FIGS. 7A-7C.

In an embodiment, portion 204 of user interface screen 200 provides a graphic that, when selected by a user, saves live video data to another portion of the navigation device 102. For example, the screen shown in FIG. 2A may correspond to a previously-discussed embodiment whereby the navigation device continuously records live video data into a rolling buffer. Continuing this example, embodiments include a user selecting portion 204, resulting in the contents of the rolling buffer being transferred to memory 118. In embodiments, a graphic (e.g., a check mark) may be presented over or shading applied to portion 204 to indicate that the live video data has been saved to memory 118.

In an embodiment, portion 206 of user interface screen 200 provides a graphic that, when selected by a user, toggles the recording mode. As shown in FIG. 2A, the recording mode is set to on, which may correspond to a default setting, one that is displayed upon the navigation device 102 detecting a suitable recording trigger, etc. In some embodiments, a user may select portion 206 to manually start, pause, and stop recording, as shown by the changes to portion 206 in FIGS. 2A-2B. In embodiments, a user selection of portion 206 may cause user interface screen 200 to present the live video data to enable a user to view the video that is being recorded. As shown in FIG. 2C, user interface screen 200 may present an “X” over portion 206 if live video data may not be obtained at the moment. For instance, memory 118 may be full or, for embodiments in which memory 118 is removable (e.g., SD card), removed from navigation device 102.

In an embodiment, portion 206 of user interface screen 200 may also function to display the current recording state as feedback regardless of whether the recording is controlled manually or automatically. For example, screen 200 of FIG. 2A may be displayed upon a user starting to drive, while of user interface screen 200 of FIG. 2B may be displayed once a storage trigger (e.g., an accident) has been detected after the recording has started, indicating that the recording has been momentarily paused so as not to lose the captured live video data within the contents of the buffer. A user may then select portion 204, as shown in FIG. 2B, to save the live video data. Of course, as previously discussed, the captured live video data may be stored automatically upon detection of the storage trigger and not require user intervention.

To provide another example, user interface screen 200, as shown in FIG. 2C, may be displayed to indicate that recording is not possible at the moment, which may be a result of a user removing memory card 118 or a result of a full memory card 118.

In an embodiment, portions 208 and 210 of user interface screen 200 facilitate user interactions with the navigation device. For example, a user may select portion 208 to open a menu to adjust settings, options, etc. A user may select portion 210 to exit the current navigation screen 200 and perform other functions provided by the navigation device, such as viewing recorded video, returning to a home screen, entering a new address or waypoint, etc.

In an embodiment, portions 212, 214, and 216 of user interface screen 200 provide navigational information to a user. For example, portion 212 may display an approximate distance to and direction of the next turn on way to the user's selected destination, while portion 214 may display the name of the street or exit (e.g., text on exit sign) that should be used to reach the selected destination. Furthermore, portion 216 may include an actively updating navigational map indicating the position of the vehicle along a designated navigation route, the vehicle's position along the route, etc.

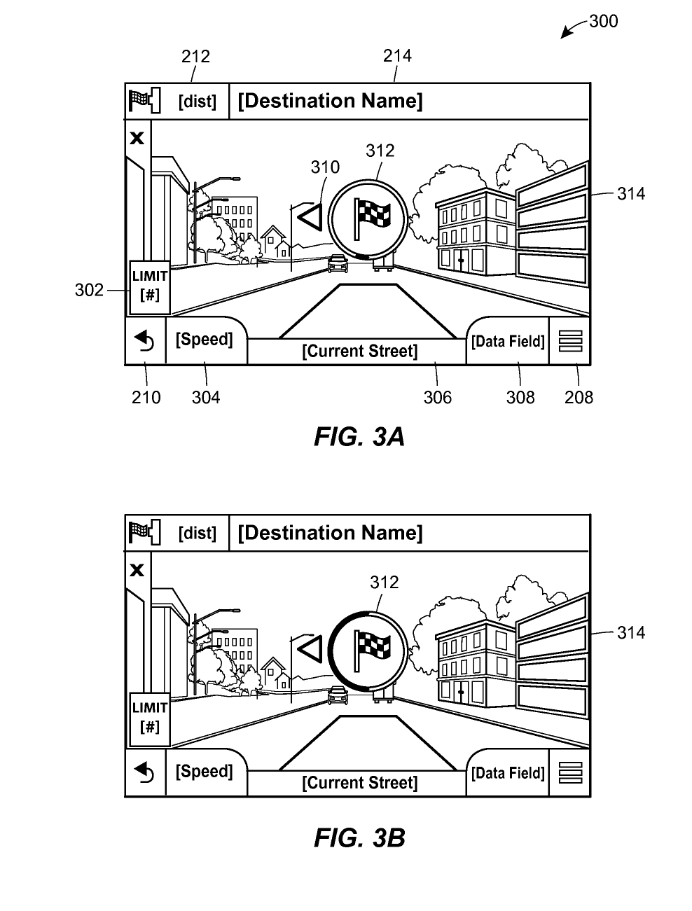

FIGS. 3A-3B are schematic illustration examples of user interface screens 300 used in conjunction with a navigation system, according to an embodiment. In these embodiments, user interface screens 300 include live video 314 of the road and/or other objects in front of the vehicle captured by camera 116 of the environment in front of the vehicle in which navigation device 102 is mounted. In an embodiment, user interface screens 300 are examples of what may be displayed on display 112 of navigation device 102, as shown and previously discussed with respect to FIG. 1.

In an embodiment, user interface screens 300 represent a different view from user interface screens 200, as shown in FIGS. 2A-2C. For example, as shown in FIG. 3A, user interface screen 300 also includes portions 208, 210, 212, and 214, as previously discussed with respect to FIGS. 2A-2C. User interface screen may alternatively or additionally include portions 302, 304, 306, and 308.

Portion 302 may indicate a speed limit for the current road on which the vehicle is traveling, the current road being displayed in portion 306. The speed limit may be part of the cartographic data that is stored in memory 118. The current calculated speed of the vehicle may also be displayed in portion 304, and any other suitable data field may be displayed in portion 308 (e.g., compass direction, a time of day, an estimated arrival time, etc.).

However, instead of displaying an actively updating navigational map in portion 216, as previously discussed with reference to FIG. 2A-2C, portion 216, as shown in FIG. 3A, indicates a view of the real time video captured by camera 116 and additional icons 310 and 312. Icon 310 includes a direction of the street on which the destination may be found, while icon 312 indicates a scaled indicator of the approximate distance remaining to the destination.

As the vehicle approaches the destination, embodiments include the circular indicator progressing in a clockwise fashion, as shown by the change in icon 312 between FIG. 3A and FIG. 3B. In various embodiments, portion 216 may transition from the actively updating navigational map shown in FIGS. 2A-2C to the real time video shown in FIGS. 3A-3B when the vehicle is within a threshold distance of the destination (e.g., less than 500 feet, less than a quarter mile, etc.). Upon transitioning, the live video may be displayed superimposed with icons 310 and 312. Additionally or alternatively, markers or other guidance tools may be overlaid on the live video data in portion 216, as shown in FIGS. 3A and 3B, to mark the destination. In this way, a user may quickly ascertain a remaining distance to a destination by looking at the live video data shown in portion 216, which incorporates a more familiar view ordinarily seen from a driver's perspective while approaching the destination.

FIGS. 4A-4D are schematic illustration examples of user interface screens 400 used to implement a navigation device in conjunction with a lane departure notification system, according to an embodiment. In an embodiment, user interface screens 400 are an example of information that may be shown on display 112 of navigation device 102, as shown and previously discussed with respect to FIG. 1.

In an embodiment, user interface screens 400 represent a different view from user interface screens 200, as shown in FIGS. 2A-2C. For example, as shown in FIG. 4A, user interface screen 400 also includes portions 202, 204, 206, 208, 210, and 216, as previously discussed with respect to FIGS. 2A-2C. User interface screens 400 may alternatively or additionally include other portions, such as portion 402, as shown in FIG. 4D and further discussed below.

In an embodiment, user interface screens 400, as shown in each of FIGS. 4A-4D, include the same actively updating navigational map in each respective portion 216 and the same driving recorder status in each respective portion 206, but the lane departure notification displayed in portion 202 is varied among each of FIG. 4A-4D. The graphic in front of the vehicle within portion 202 likewise indicates that the collision notification system is enabled in each of FIGS. 4A-4D, the details of which are further discussed with reference to FIGS. 7A-7C.

As shown in FIG. 4A, portion 202 includes a right lane line marker 402 to the right of the vehicle icon, but no line to the left of the vehicle icon. In an embodiment, portion 202, as shown in FIG. 4A, corresponds to a situation in which navigation device 102 has detected and is tracking a road lane line on the right side of the vehicle, but has not detected and is not tracking a road lane line to the left of the vehicle. This situation could represent the absence of a road lane line on the left side of the vehicle, a period of time in which the vehicle turned onto the road before navigation device 102 has been able to identify the left road lane line, a brief non-continuous segment of the left road lane line, etc.

In accordance with the information shown in portion 202, as shown in FIG. 4A, embodiments include navigation device 102 tracking the right road lane line such that, when the vehicle crosses over this lane line, the alarm will be issued. Departure of the vehicle to the left side may not result in the issuance of an alert because, as shown in FIG. 4A, the left road lane line is not being tracked.

As previously discussed, the cartographic data stored in navigation device 102 may be leveraged by processor 110 to determine whether to issue an alert when the vehicle crosses a road lane line. As shown in FIG. 4B, the navigation device 102 is tracking both the left and the right road lane lines, but will only issue an alert for the departure of the vehicle over the right road lane line, which is indicated by the muted left lane line marker 404 to the left of the vehicle icon as shown in portion 202.

In the scenario illustrated by FIG. 4B, navigation device 102 may determine, for example, that the lane line to the right of the vehicle is a solid lane line, thereby unconditionally issuing an alert when the vehicle crosses this lane line regardless of the type of road. Further continuing this example, navigation device 102 may determine that the road lane line to the left of the vehicle is a dashed road lane line and, from the cartographic data stored in memory of navigation device 102, that the vehicle crossing the left road lane line would not cause the vehicle to cross into oncoming traffic. Therefore, as indicated by indicated by the right lane line marker 402 and muted left lane line marker 404, as shown in portion 202 of FIG. 4B, navigation device 102 may issue an alert when the vehicle crosses the right road lane line, but suppress the alert when the vehicle crosses the left road lane line.

In the scenario illustrated by FIG. 4C, the navigation device 102 is tracking both the left and the right road lane lines and will issue an alert for the departure of the vehicle over either one of these lanes, which is indicated by the right lane line marker 402 and the left lane line marker 404 in portion 202 of FIG. 4C, which may have the same color, shading, etc.

In the scenario illustrated by FIG. 4C, navigation device 102 may determine, for example, that the lane line to the right of the vehicle is a solid lane line, thereby unconditionally issuing an alert when this lane is crossed regardless of the type of road. Further continuing this example, navigation device 102 may determine that the road lane line to the left of the vehicle is a dashed road lane line and, from the cartographic data stored in memory of navigation device 102, that crossing the left road lane line would cause the vehicle to cross into oncoming traffic. Therefore, as indicated by indicated by the right lane line marker 402 and left lane line marker 404, as shown in portion 202 of FIG. 4C, navigation device 102 may issue an alert when the vehicle crosses either the right road lane line or the left road lane line.

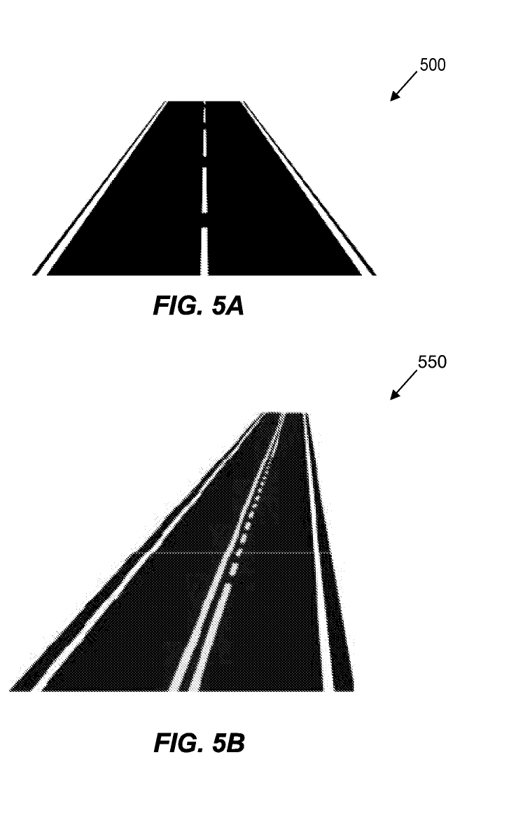

The difference between the scenarios in FIGS. 4B and 4C may be further illustrated with reference to FIGS. 5A-5B. FIG. 5A illustrates an example of a one-way street, while FIG. 5B illustrates a two-lane undivided highway. In either case, navigation device 102 may issue an alert when the vehicle crosses the right road lane line, as this line is solid in both cases.

However, if navigation device 102 determines, from the cartographic data, that the vehicle is traveling on the one-way street of FIG. 5A, then navigation device 102 may suppress the issuance of an alarm when the vehicle moves across the left dashed road lane line, as indicated by the muted left lane line marker 404 to the left of the vehicle icon as shown in portion 202 of FIG. 4B.

Furthermore, if navigation device 102 determines, from the cartographic data, that the vehicle is traveling on the undivided highway of FIG. 5B where the center right lane becomes broken—indicating a passing lane, then navigation device 102 may cause an alert to be issued when the vehicle departs either the right road lane line or the left road lane line, as indicated by the left lane line marker 404 in portion 202 of FIG. 4C.

In the scenario illustrated by FIG. 4D, the navigation device is tracking both the left and the right road lane lines and has issued an alert for the vehicle crossing the left road lane line. Again, the alert may be issued via any suitable combination of warnings displayed on screen 400 (e.g., portion 406) and/or audible warnings. Embodiments include the left lane line marker 404, as shown in FIG. 4D, changing color, shading, line weight, etc., from the left lane line marker 404, as shown in FIG. 4C, to indicate that the left road lane line has been crossed by the vehicle.

The indicators shown in portion 202 of FIGS. 4A-4D may be represented by any suitable type of indicator to convey the information represented by the road lane lines to the left and right of the vehicle icon, such as different line weights, color schemes, the use of broken lines, color muting, fading, etc. For example, a road lane line that will result in the issuance of an alert when crossed may be displayed in a different color than a road lane line that will not. To provide another example, a road lane line that will result in the issuance of an alert when crossed may be displayed in one color while a road lane line that will not may be grayed out or faded. To provide yet another example, a road lane line color may change when crossed and when an alert has been issued (e.g., from green to yellow or red).

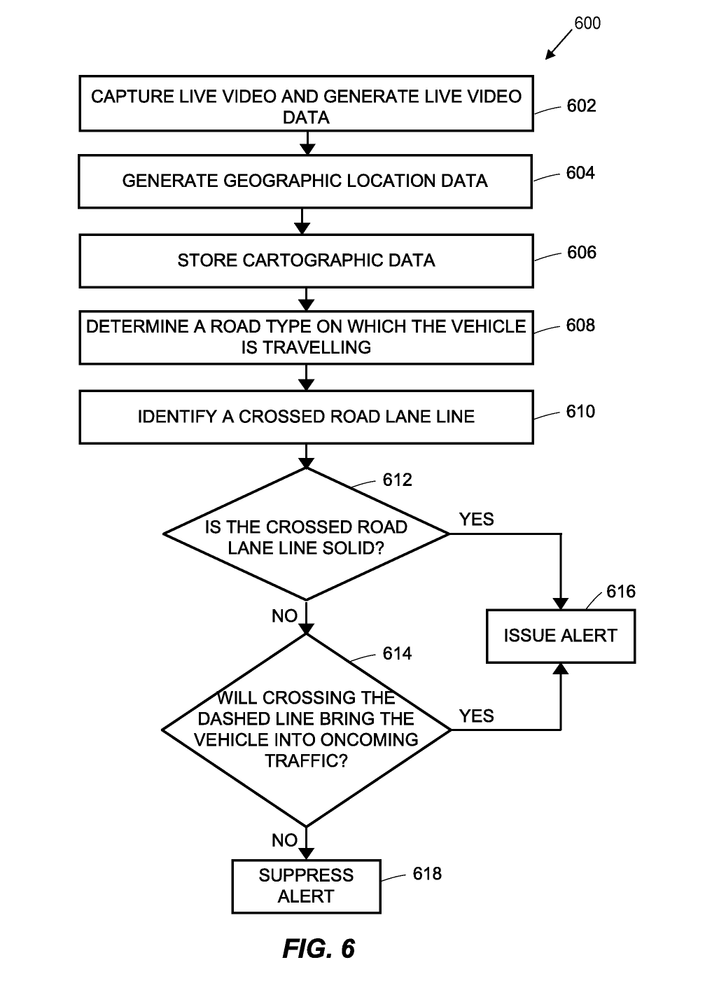

FIG. 6 illustrates a method flow 600, according to an embodiment. In an embodiment, one or more regions of method 600 (or the entire method 600) may be implemented by any suitable device. For example, one or more regions of method 600 may be performed by navigation device 102, as shown in FIG. 1.

In an embodiment, method 600 may be performed by any suitable combination of one or more processors, applications, algorithms, and/or routines, such as processor 110 executing instructions stored in lane departure notification module 122, for example, as shown in FIG. 1. Further in accordance with such an embodiment, method 600 may be performed by one or more processors working in conjunction with one or more components within a navigation device, such as one or more processors 110 working in conjunction with one or more of communication unit 104, user interface 106, sensor array 108, display 112, location determining component 114, camera 116, memory 118, etc.

Method 600 may start when one or more processors capture live video and generate live video data (block 602). In an embodiment, the live video data may include, for example, dash cam video such as a view of a road in front of the vehicle in which navigation device 102 is mounted (block 602). The live video data may include, for example, road lane line markers on the road (block 602).

Method 600 may include one or more processors 110 generating geographic location data indicative of a geographic location of the navigation device (block 604). This may include, for example, location determining component 114 and/or processor 110 receiving and processing one or more GNSS signals to generate the geographic location data (block 604).

Method 600 may include one or more processors 110 storing cartographic data (block 606). The cartographic data may include, for example, information regarding road types, speed limits, road architecture, lane layouts, etc. (block 606). The cartographic data may be preinstalled or otherwise downloaded to memory 118 (block 606).

Method 600 may include one or more processors 110 determining a road type on which the vehicle is traveling (block 608). This determination may be made, for example, by processor 110 referencing the cartographic data stored by one or more processors 110 (block 606) to the geographic location data generated one or more processors 110 (block 604) to identify the type of road on which the vehicle is traveling as a one-way street, a divided highway, an undivided highway, etc. (block 608).

Method 600 may include one or more processors 110 identifying when a road lane line has been crossed by the vehicle (block 610). This determination may be made, for example, by processor 110 analyzing movements of the road lane lines within the live video data, as previously discussed with reference to FIG. 1 (block 610).

Method 600 may include one or more processors 110 determining whether a crossed road lane line is a solid line (block 612). This may include, for example, one or more processors 110 comparing pixel dimensions among lines identified via a suitable edge detection process, as previously discussed with reference to FIG. 1, to differentiate between solid and dashed road lane lines (block 612).

If the crossed road lane line is solid, method 600 may include one or more processors 110 causing an alert to be issued (block 616). In an embodiment, the one or more processors 110 may cause the alert to be issued each time a solid road lane line is crossed regardless of the road type (block 616). Again, the issued alert may be any suitable combination of visual and/or audible warnings (block 616).

If the crossed road lane line is not a solid line, then method 600 may include one or more processors 110 determining whether crossing the dashed road lane line will cause the vehicle to move into oncoming traffic (block 614). This may be determined by comparing the road type determined by one or more processors 110 for the road on which the vehicle is traveling (block 608) to the lane position of the vehicle within the road (block 614). If so, method 600 may include one or more processors 110 causing an alert to be issued (block 616). If not, method 600 may include one or more processors 110 suppressing the alert (block 618).

FIGS. 7A-7C are schematic illustration examples of user interface screens 700 used to implement a navigation device in conjunction with a collision notification system, according to an embodiment. In an embodiment, user interface screens 700 are an example of information that may be shown on display 112 of navigation device 102, as shown and previously discussed with respect to FIG. 1.

In an embodiment, user interface screens 700 represent a different view of both user interface screens 200, as shown in FIGS. 2A-2C, and user interface screens 400, as shown in FIGS. 4A-4C. For example, as shown in FIG. 7A, user interface screen 700 also includes portions 202, 204, 206, 208, 210, 212, and 214, as previously discussed with respect to FIGS. 2A-2C. User interface screens 700 may alternatively or additionally include other portions, such as portion 704, as shown in FIG. 7C and further discussed below.

User interface screens 700, in each of FIGS. 7A-7C, show the same actively updating navigational map in each respective portion 216, the same driving recorder status in each respective portion 206, and the same lane departure notification indicia in portion 202, but the collision notification system graphics in portion 202 is varied among each of FIGS. 7A-7C. More specifically, icon 702 in front of the vehicle within portion 202 varies between each of FIG. 7A-7C.

As shown in FIG. 7A, portion 202 of user interface screen 700 includes a vehicle icon but does not include icon 702. In an embodiment, portion 202, as shown in FIG. 7A, corresponds to a situation in which the collision notification system is not enabled and/or is not currently active. This situation could occur, for example, if a user has manually disabled the collision notification system via one or more selected options. In some embodiments, the activation of the collision notification system may be automatically enabled once the vehicle speed exceeds a threshold value (e.g., 5 mph, 10 mph, etc.). In accordance with such embodiments, icon 702 may be absent until the threshold speed has been attained, in which case the collision notification system may be activated and icon 702 may be present in portion 202, as shown FIG. 7B.

In the scenario illustrated by FIG. 7B, portion 202 of user interface screen 700 indicates that the collision notification system has been enabled. In accordance with an embodiment, upon activation of the collision notification system, processor 110 may begin classifying live video data but continue to display the actively updating navigational map in portion 216. In other words, embodiments include processor 110 classifying live video data as part of a background process while the user is still able to utilize the navigation functions provided by the navigation device 102.

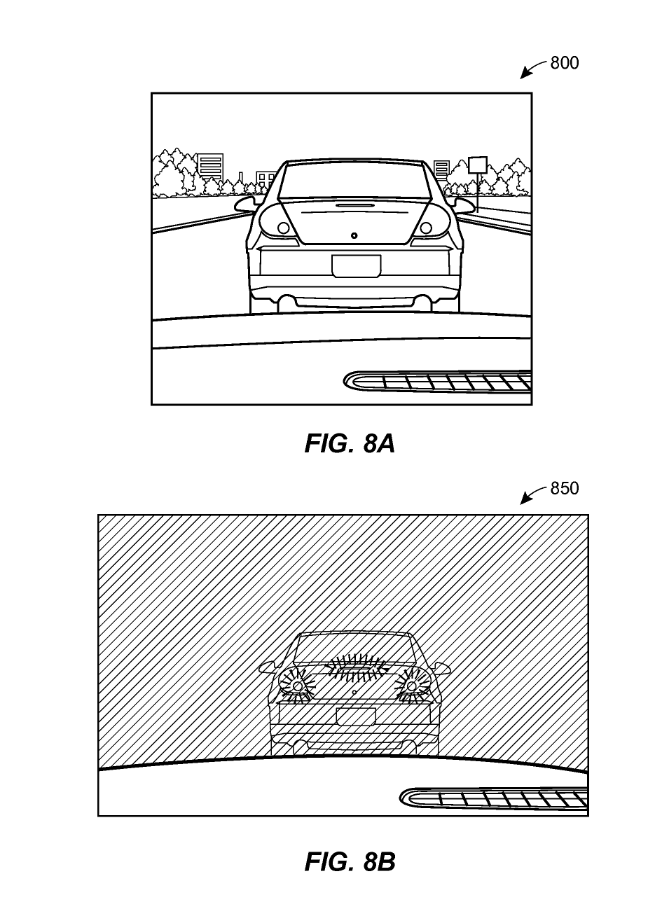

An example of live video data that may be captured while the collision notification system is enabled is shown in FIG. 8A-8B, each indicating a sample frame of live video data captured during the daytime (800) and nighttime (850). A comparison between the live video data frames 800 and 850 demonstrate the stark differences between rear vehicle features for live video data captured during the daytime versus the nighttime. Because the classification process attempts to identify these features and thus identify the vehicle within the live video feed, the use of daytime and nighttime training data models may advantageously allow for the classification system to adapt to these changes.

Again, when the collision notification system is active, as indicated by the graphic shown in portion 202 of FIG. 7B, embodiments include processor 110 classifying live video captured during the daytime (e.g., live video data frame 800) using a classification process that compares features of the daytime live video feed to daytime training data models. Furthermore, when the collision notification system is active, embodiments include processor 110 classifying live video captured during the nighttime (e.g., live video data frame 850) using a classification process that compares features of the nighttime live video feed to nighttime training data models.

Again, when a vehicle in the captured live video data is identified, embodiments include processor 110 calculating an estimated distance between the navigation device 102 (and the vehicle within which the navigation device 102 is located) and the identified vehicle using any suitable techniques, as previously discussed with reference to FIG. 1. In an embodiment, this calculation may also be performed while screen 700 is displayed, as shown in FIG. 7B, allowing a user to continue to utilize navigational functions provided by navigation device 102.

In the scenario illustrated by FIG. 7C, portion 202 indicates that the collision notification system has detected that the calculated estimated distance between navigation device 102 (and the vehicle within which the navigation device 102 is located) and the vehicle identified in the live video data is less than a threshold RFD, causing processor 110 to issue an alert. Again, the alert may be issued via any suitable combination of warnings displayed on screen 700 (e.g., portion 704) and/or audible warnings. Embodiments include navigation device 102 issuing the alert while still providing navigation functions.

Embodiments include icon 702, as shown in portion 202 of FIG. 7B, changing color, shading, line weight, etc., to illustrate that an alert has been detected, as shown in FIG. 7C. The change between these states may be shown using any suitable type of indicators, such as changes in color, muting, fading, etc. For example, icon 702, as shown in FIG. 7B, may be one color to indicate that the collision notification system is active (e.g., green) but change to another color when the alert is issued (e.g., red), as shown in FIG. 7C.

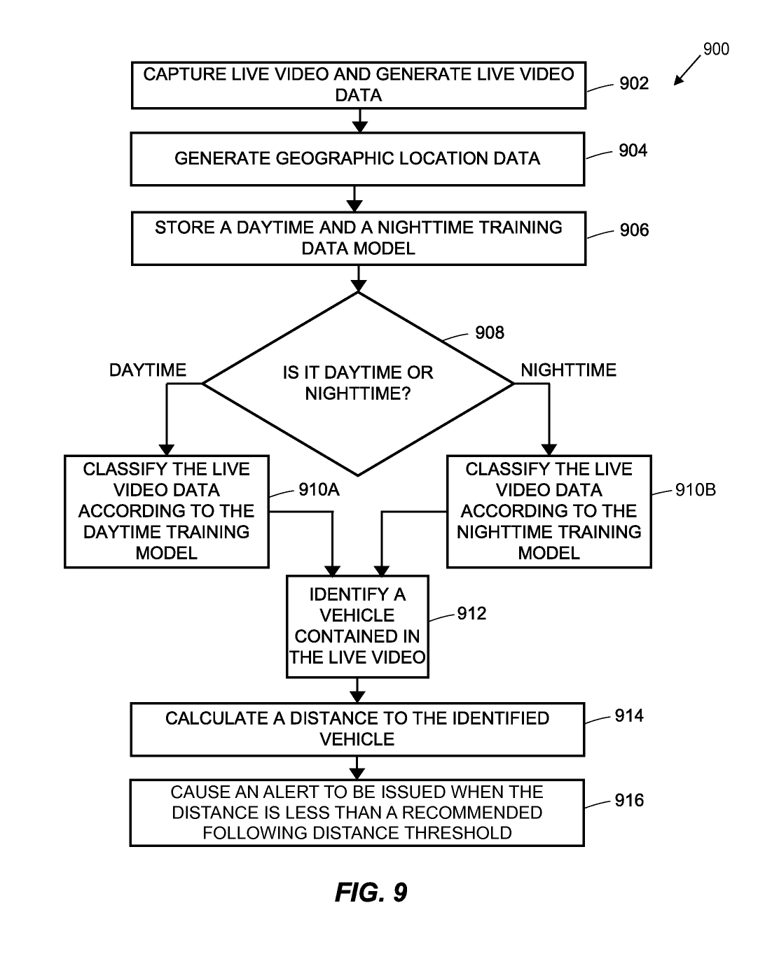

FIG. 9 illustrates a method flow 900, according to an embodiment. In an embodiment, one or more regions of method 900 (or the entire method 900) may be implemented by any suitable device. For example, one or more regions of method 900 may be performed by navigation device 102, as shown in FIG. 1.

In an embodiment, method 900 may be performed by any suitable combination of one or more processors, applications, algorithms, and/or routines, such as processor 110 executing instructions stored in collision notification module 124, for example, as shown in FIG. 1. Further in accordance with such an embodiment, method 900 may be performed by one or more processors working in conjunction with one or more other components within a navigation device, such as processor 110 working in conjunction with one or more of communication unit 104, user interface 106, sensor array 108, display 112, location determining component 114, camera 116, memory 118, etc.

Method 900 may start when one or more processors 110 capture live video and generate live video data (block 902). In an embodiment, the live video data may include, for example, dash cam video such as a view of a road in front of the vehicle in which navigation device 102 is mounted (block 902).

Method 900 may include one or more processors 110 generating geographic location data indicative of a geographic location of the navigation device 102 (block 904). This may include, for example, location determining component 114 and/or processor 110 receiving and processing one or more GNSS signals to generate the geographic location data (block 904).

Method 900 may include one or more processors 110 storing a daytime and a nighttime training data model (block 906). The daytime training data model may include, for example, training data including a first range of video data metrics that identify a portion of a vehicle contained within the live video data during the daytime (block 906). The nighttime training data model may include, for example, training data including another range of video data metrics that identify a portion of a vehicle contained within the live video data during the nighttime (block 906).

Method 900 may include one or more processors 110 determining whether it is daytime or nighttime based upon the geographic location data and a time of day (block 908). Again, the daytime/nighttime determination may be performed using any suitable techniques, such as the referencing the geographic location data (block 904) to data stored in memory 118 to determine sunrise/sunset times and comparing the time of day to the sunrise/sunset times (block 908).

If the one or more processors 110 determine that is it daytime (block 908), then method 900 may include the one or more processors 110 classifying the live video data according to the daytime training model (block 910A) that is stored in memory (block 906). But if the one or more processors 110 determine that is it nighttime (block 908), then method 900 may include the one or more processors 110 classifying the live video data according to the nighttime training model (block 910B) that is stored in memory (block 906). Again, this classification may be performed utilizing any suitable number and/or types of classifier algorithms (blocks 910A and 910B).

Method 900 may include one or more processors 110 identifying the vehicle contained within the live video (block 912) using the applied classification algorithm (block 910A or 910B). For example, when installed within a vehicle, method 900 may include one or more processors 110 identifying a vehicle in front of the vehicle in which the navigation device 102 is installed (block 912).

Method 900 may include one or more processors 110 calculating an estimated distance from the navigational device 102 to the identified vehicle (block 912) using the portion of the vehicle contained within the live video data (block 914). This may include, for example, one or more processors 110 performing an inverse perspective transform on the live video data to determine this estimated distance (block 914).

Method 900 may include one or more processors 110 causing an alert to be issued based upon the estimated distance (block 916). This alert may be, for example, a visual and/or audible alert generated by the navigation device 102 (block 916). The alert may be issued, for example, when the calculated estimated distance between the navigation device 102 (and the vehicle within which the navigation device 102 is located) and the vehicle (block 914) is less than a RFD threshold (block 916).

Although the foregoing text sets forth a detailed description of numerous different embodiments, it should be understood that the detailed description is to be construed as exemplary only and does not describe every possible embodiment because describing every possible embodiment would be impractical, if not impossible. In light of the foregoing text, numerous alternative embodiments may be implemented, using either current technology or technology developed after the filing date of this patent application.

What is claimed is:

1. A navigational device, comprising:
a camera configured to capture live video in front of a first vehicle in which the navigational device is mounted and to generate live video data;
a location determining component configured to generate geographic location data indicative of a geographic location of the navigation device;
a memory configured to store a first training data model corresponding to a first range of video data metrics that identify a portion of a second vehicle is contained within the live video data during the daytime, and a second data training model corresponding to a second range of video data metrics that identify the portion of the second vehicle is contained within the live video data during the nighttime; and
a processor configured to:
determine whether it is daytime or nighttime based upon the geographic location data and a time of day,
classify the live video data according to the first model when it is daytime, and classify the live video data according to the second model when it is nighttime,
identify the second vehicle contained within the live video,
calculate an estimated distance from the navigational device to the second vehicle using the portion of the second vehicle contained within the live video data, and
selectively cause a first alert to be issued based upon the estimated distance.

2. The navigational device of claim 1, wherein the processor is further configured to calculate the estimated distance from the navigational device to the second vehicle by applying an inverse perspective transform to the live video data.

3. The navigational device of claim 2, wherein the processor is further configured to determine a speed of the first vehicle based on the geographic location data, calculate a recommended following distance (RFD) threshold based upon the speed of the first vehicle, and cause the first alert to be issued when the estimated distance from the navigational device to the second vehicle is less than the RFD threshold.

4. The navigational device of claim 3, wherein the processor is further configured to adjust the RFD threshold such that the RFD threshold is greater when it is nighttime than when it is daytime.

5. The navigational device of claim 1, wherein the location determining component is further configured to receive a global navigational satellite system (GNSS) signal, and
wherein the processor is further configured to determine the time of day based upon the GNSS signal.

6. The navigational device of claim 5, further comprising:
a memory configured to store cartographic data including an indication of road types, and
wherein the processor is further configured to determine a road type corresponding to the road lane in which the first vehicle is traveling by referencing the geographic location data to the cartographic data.

7. The navigational device of claim 6, wherein the processor is further configured to determine whether a road lane line is a solid or a dashed road lane line.

8. The navigational device of claim 7, wherein the processor is further configured to identify when the first vehicle has crossed the road lane line and cause a second alert to be issued when the first vehicle crosses a solid road lane line.

9. The navigational device of claim 8, wherein the processor is further configured to cause the second alert to be issued when the first vehicle crosses a dashed road lane line and the type of road indicates that the first vehicle is potentially crossing into oncoming vehicular traffic, and to otherwise suppress the second alert from being issued.

10. A navigational device, comprising:
a camera configured to capture live video in front of a first vehicle in which the navigational device is mounted and to generate live video data;
a location determining component configured to generate geographic location data indicative of a geographic location of the navigation device;
a memory configured to store cartographic data including an indication of road types; and
a processor configured to:
determine a type of road on which the first vehicle is traveling by referencing the geographic location data to the cartographic data,
identify when the first vehicle has crossed a road lane line,
determine whether the road lane line is a solid or a dashed road lane line,
cause a first alert to be issued when the first vehicle crosses a solid road lane line, and
cause the first alert to be issued when the first vehicle crosses a dashed road lane line and the type of road indicates that the first vehicle is potentially crossing into oncoming vehicular traffic, and to otherwise suppress the first alert from being issued.

11. The navigational device of claim 10, wherein the processor is configured to cause the first alert to be suppressed when the vehicle crosses the dashed road lane line and is entering a different lane in the same direction of travel.

12. The navigational device of claim 10, wherein the memory is further configured to store a first training data model corresponding to a first range of video data metrics that identify a portion of a second vehicle contained within the live video data during the daytime, and a second data training model corresponding to a second range of video data metrics that identify the portion of the second vehicle contained within the live video data during the nighttime, and
wherein the processor is further configured to:
determine whether it is daytime or nighttime based upon the geographic location data and a time of day,
classify the live video data according to the first model when it is daytime or classify the live video data according to the second model when it is nighttime,
calculate an estimated distance from the navigational device to the second vehicle using the portion of the second vehicle contained within the live video data, and
selectively cause a second alert to be issued based upon the estimated distance.

13. The navigational device of claim 12, wherein the processor is further configured to calculate the estimated distance from the navigational device to the second vehicle by applying an inverse perspective transform to the live video data.

14. The navigational device of claim 13, wherein the processor is further configured to determine a speed of the first vehicle based on the geographic location data, calculate a recommended following distance (RFD) threshold based upon the speed of the first vehicle, and cause the second alert to be issued when the estimated distance from the navigational device to the second vehicle is less than the RFD threshold.

15. The navigational device of claim 14, wherein the processor is further configured to adjust the RFD threshold such that the RFD threshold is greater when it is nighttime than when it is daytime.

16. The navigational device of claim 10, wherein the location determining component is further configured to receive a global navigational satellite system (GNSS) signal, and
wherein the processor is further configured to determine the time of day based upon the GNSS signal.

17. A computer-implemented method in a navigational device, comprising:
capturing, using one or more processors, live video in front of a first vehicle in which the navigational device is mounted;
generating, using the one or more processors, live video data based on the live video;
generating, using the one or more processors, geographic location data indicative of a geographic location of the navigation device;
storing, by one or more processors, a first training data model corresponding to a first range of video data metrics that identify a portion of a second vehicle contained within the live video data during the daytime, and a second data training model corresponding to a second range of video data metrics that identify the portion of the second vehicle contained within the live video data during the nighttime;
storing, using the one or more processors, cartographic data including an indication of road types;
determining, using the one or more processors, whether it is daytime or nighttime based upon the geographic location data and a time of day,
classifying, using the one or more processors, the live video data according to the first model when it is daytime,
classifying, using the one or more processors, the live video data according to the second model when it is nighttime,
identifying, using the one or more processors, a second vehicle contained within the live video data;
calculating, using the one or more processors, an estimated distance from the navigational device to the second vehicle using the portion of the second vehicle contained within the live video data,
selectively issuing, using the one or more processors, a first alert based upon the estimated distance from the navigational device to the second vehicle;
determining, using the one or more processors, a type of road on which the first vehicle is traveling by referencing the geographic location data to the cartographic data;
determining, using the one or more processors, whether a road lane line is a solid or a dashed road lane line;
identifying, using the one or more processors, when the first vehicle has crossed the road lane line;
issuing, using the one or more processors, a second alert when the first vehicle crosses a solid road lane line, and
issuing, using the one or more processors, the second alert when the first vehicle crosses a dashed road lane line and the type of road indicates that the first vehicle is potentially crossing into oncoming vehicular traffic, and otherwise suppressing the second alert.

18. The computer-implemented method of claim 17, wherein the act of calculating the estimated distance from the navigational device to the second vehicle comprises:
applying, by one or more processors, an inverse perspective transform to the live video data.

19. The computer-implemented method of claim 18, further comprising:
calculating, using the one or more processors, a speed of the first vehicle based on the geographic location data;
calculating, using the one or more processors, a recommended following distance (RFD) threshold based upon the speed of the first vehicle; and
adjusting, using the one or more processors, the RFD threshold such that the RFD threshold is greater when it is nighttime than when it is daytime, and wherein the act of issuing the first alert comprises:
issuing the first alert when the estimated distance from the navigational device to the second vehicle is less than the RFD threshold.

20. The computer-implemented method of claim 17, further comprising:
receiving, using the one or more processors, a global navigational satellite system (GNSS) signal, and
determining, using the one or more processors, the time of day based upon the GNSS signal.
